(19) United States
(12) Patent Application Publication
(10) Pub. No.: US 2010/0076110 A1
(43) Pub. Date: Mar. 25, 2010

(54) REACTIVE POLYMER AND HARD COATING COMPOSITION

(76) Inventors: Chang-Jian Weng, Chiayi City (TW); Shih-Pin Lin, Taipei City (TW); Ming-Huei Chen, Taoyuan County (TW); Chin-Sung Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/562,157

(22) Filed: Sep. 18, 2009

(30) Foreign Application Priority Data
Sep. 18, 2008 (TW) 097135755

(51) Int. Cl. C09D 183/04; C08G 77/388

(52) U.S. Cl. 522/99; 528/332; 528/26; 528/67

(57) ABSTRACT

Disclosed is a reactive polymer of the following representative formula: R₄—R_{3b}—NH—CO—R_{2b}—CO—NH—R₁—NH—CO—R₂ₐ—CO—NH—R₃ₐ—R₄ wherein R₁ is alkylene, arylene or the combination thereof, R₂ₐ or R_{2b} is a linker, R₃ₐ and R_{3b} is a cross-linked poly —Si—O— group, and R₄ is a vinyl functional group.

### BACKGROUND OF THE INVENTION

1. Field of the Invention

The present invention generally relates to a reactive polymer for use in a polarizer and in a flat panel display, a hard coating composition including such reactive polymer and a method for making the reactive polymer. In particular, the present invention relates to a modifier for a hard coating composition to increase the hardness of the hard coating composition.

2. Description of the Prior Art

Currently, a polarizer for use in the outer surface of a flat panel display is mainly composed of a three-layer structure formed by polyvinyl alcohol (PVA) sandwiched between two layers of triacetate cellulose (TAC). Although triacetate cellulose is well transparent, triacetate cellulose has insufficient surface hardness. Solutions for its surface treatment are being proposed to provide the triacetate cellulose with better surface properties or to add addition optical properties to the triacetate cellulose. The current modifiers are hard coating layers, anti-glare films, or anti-reflection films . . . etc. Hard coating layers are used to strengthen the substrate and to protect the surface of the substrate.

There are some known hard coating layers to strengthen the substrate and to protect the surface of the substrate. For example, U.S. Pat. No. 6,376,060 discloses a hard coating layer. The composition of the hard coating layer is an organic material including polymerizable function groups as well as an inorganic filler. In addition, U.S. Pat. No. 6,329,041 discloses another hard coating film. First, one or several buffer layers of total thickness up to several to tens of micrometer are coated on one side of the substrate, then a UV-type coating of several micrometer thickness is coated on the buffer layer. Again for the thermoset resins, U.S. Pat. No. 6,773,778 discloses another hard coating film including a siloxane hard coating. However, such siloxane hard coating intrinsically brittle due to its inorganic origin and it takes longer time to cure. Accordingly, most hard coatings are still photo-curing based.

Traditionally, the conventional UV-type hard coating resins are mainly organic. The main ingredients of such hard coating resins are reactive monomers, reactive oligomers and photo initiators . . . etc. In the developing market, the demands on the hard coating layers are higher and higher. Although the hardness of the hard coating composition may be increased by adjusting the numbers of the reactive functional groups in the hard coating composition, however, on the other hand, this solution may seriously jeopardize the volume flexibility of the entire material and accordingly leads to a serious curling problem of the optical film.

Given the above, it is still needed to provide a novel modifier for a hard coating composition. On one hand, such novel modifier may increase the hardness of the hard coating composition. On the other hand, such novel modifier may keep the hard coating composition from curling.

### SUMMARY OF THE INVENTION

The present invention proposes an outer hard coating modifier for use in the polarizer and in the flat panel display as well as a method for making the hard coating modifier. The present invention also proposes a liquid coating composition for use in an optical coating film on the polarizer. The optical coating film formed by the liquid coating composition of the present invention may be used in all kinds of flat panel displays, such as computers, TVs, car dash boards, or the outermost hard coating film in a multilayer durable optical film.

The triacetate cellulose without surface treatment has a pencil hardness of about H to B, and accordingly is susceptible to damages caused by contact or scratch. Although there are known hard coating compositions for the improvement of the surface hardness of the triacetate cellulose and the hardness of the hard coating compositions may be increased by adjusting the numbers of the reactive functional groups in the hard coating composition, however this solution may seriously jeopardize the volume flexibility of the entire material and accordingly leads to serious curling problem of the optical film.

The present invention is directed to propose a UV-polymerizable hard coating material of high durability. The UV-polymerizable hard coating material of high durability may form an optical film of optical-grade on a substrate if it goes with a wet coating process to substantially protect the substrate from the damages caused by contact or by scratch. In addition, the UV-polymerizable hard coating material of high durability of the present invention has good wear-resistance, good adhesion and good transparency.

The present invention first proposes a reactive polymer. The reactive polymer has the following representative formula:

R₄—R_{3b}—NH—CO—R_{2b}—CO—NH—R₁—NH—CO—R₂ₐ—CO—NH—R₃ₐ—R₄

wherein,
R₁ is alkylene, arylene or the combination thereof;
R₂ₐ is —{[O—(CH₂)ₐ]_{b}}—O—
or

—O[—(CH₂)_{d}—OOC—(CH₂)_{d}—COO]ₑ}—(CH₂)_{d}—O—,

wherein a is between 2 and 50, b is between 1000 and 2000, d is between 2 and 50 and e is between 1000 and 2000;
R_{2b} is —{[O—(CH₂)ₕ]ₖ}—O—
or

—O[—(CH₂)_{f}—OOC—(CH₂)_{f}—COO]_{g}}—(CH₂)_{f}—O—,

wherein h is between 2 and 50, k is between 1000 and 2000, f is between 2 and 50 and g is between 1000 and 2000;
R₃ₐ is a cross-linked poly (—Si—O—) group;
R_{3b} is a cross-linked poly (—O—Si—) group; and
R₄ is a vinyl functional group.

The present invention further proposes a hard coating composition. The hard coating composition of the present invention includes a reactive polymer, an acrylic-type monomer, an acrylic-type oligomer and a photo initiator. The reactive polymer has the following representative formula:

R₄—R_{3b}—NH—CO—R_{2b}—CO—NH—R₁—NH—CO—R₂ₐ—CO—NH—R₃ₐ—R₄

wherein,
R₁ is alkylene, arylene or the combination thereof,
R₂ₐ is —{[O—(CH₂)ₐ]_{b}}—O—
or

—O[—(CH₂)_{d}—OOC—(CH₂)_{d}—COO]ₑ}—(CH₂)_{d}—O—,

wherein a is between 2 and 50, b is between 1000 and 2000, d is between 2 and 50 and e is between 1000 and 2000,
R_{2b} is —{[O—(CH₂)ₕ]ₖ}—O—
or

—O[—(CH₂)_{f}—OOC—(CH₂)_{f}—COO]_{g}}—(CH₂)_{f}—O—,

wherein h is between 2 and 50, k is between 1000 and 2000, f is between 2 and 50 and g is between 1000 and 2000;
R₃ₐ is a cross-linked poly (—Si—O—) group,
R_{3b} is a cross-linked poly (—O—Si—) group, and
R₄ is a vinyl functional group.

The present invention again proposes a method to make a reactive polymer, including:

reacting a compound of formula (17) with an excessive amount of a compound of formula (18) to obtain a compound of formula (20).

The compound of formula (17) is

H—(O—Si)_{S+1}—NH—CO—R_{2b}—CO—NH—R₁—NH—CO—R₂ₐ—OC—NH —(Si—O)_{P+1}—H,

wherein R₁ is alkylene, arylene or the combination thereof,
R₂ₐ is —{[O—(CH₂)ₐ]_{b}}—O—
or

—O[—(CH₂)_{d}—OOC—(CH₂)_{d}—COO]ₑ}—(CH₂)_{d}—O—,

wherein a is between 2 and 50, b is between 1000 and 2000, d is between 2 and 50 and e is between 1000 and 2000;
R_{2b} is —{[O—(CH₂)ₕ]ₖ}—O—
or

—O[—(CH₂)_{f}—OOC—(CH₂)_{f}—COO]_{g}}—(CH₂)_{f}—O—,

wherein h is between 2 and 50, k is between 1000 and 2000, f is between 2-50 and g is between 1000-2000, p is between 2-50, s is the same as p, (Si—O)_{P+1} and (O—Si)_{S+1} respectively represent a cross-linked poly (—Si—O—) group.

The compound of formula (18) is

[AR—(CH₂)ₜ—Si—(OR₁₂)₃],

wherein AR is a vinyl functional group,
R₁₂ is a C₁-C₁₀ alkyl group, and
t is between 2-10.

The compound of formula (20) is

[AR—(CH₂)ₜ—]ₘ—(O—Si)_{S+2}—NH—CO—R_{2b}—CO—NH—R₁—NH—CO—R₂ₐ—OC—NH—(Si—O)_{P+2}—[(CH₂)ₜ—AR]ₙ,

wherein m is between 1 and 10, n is between 1 and 10.

When the reactive polymer of the present invention as a hard coating modifier is used together with a conventional hard coating composition, not only does the hardness of the hard coating composition increase, but also the optical film obtained from the hard coating modifier of the present invention avoids the traditional disadvantageous curling problem.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates the modifier in the hard coating composition of the present invention with alternate hard and soft chains.

FIG. 2 illustrates the chemical formulae of the representative examples of the reactive polymers of the present invention.

FIG. 3 illustrates the compound of formula (17) reacting with an excessive amount of the compound of formula (18) to obtain the compound of formula (20).

FIG. 4 illustrates the compound of formula (15) reacting with an excessive amount of the compound of formula (16) to obtain the compound of formula (17).

FIG. 5 illustrates the compound of formula (13) reacting with an excessive amount of the compound of formula (14) to obtain the compound of formula (15).

FIG. 6 illustrates the compound of formula (II) reacting with an excessive amount of the compound of formula (12) to obtain the compound of formula (13).

FIG. 7 illustrates the characteristic absorption of the representative function groups.

### DETAILED DESCRIPTION

The present invention generally relates to a hard coating modifier for use in the polarizer and in the flat panel display. The hard coating modifier of the present invention per se is a reactive polymer composed of multiple oligomer moieties. One of the multiple oligomer moieties is a polyol or polyester type polyurethane prepolymer with alternate hard and soft chains, another moiety is a silica-formed 3D cross-linked structure, plus a vinyl functional group with photo-polymerizable activity. The hard coating modifier of the present invention in combination with the traditional hard coating composition may efficiently strengthen the hardness of the hard coating material if it goes with a wet coating process to avoid the traditional disadvantageous curling problem. A transparent optical film of high hardness is accordingly obtained.

The hard coating composition of the present invention is based on a UV hard coating recipe. The hard coating composition of the present invention may be used along with the transparent soft substrate, such as poly(ethylene terephthalate) (PET), triacetate cellulose (TAC) or polymethyl methacrylate (PMMA). The substrate is usually coated with a layer of hard coating of 5-10 micrometer in order to protect the substrate from the damages caused by contact or by scratch.

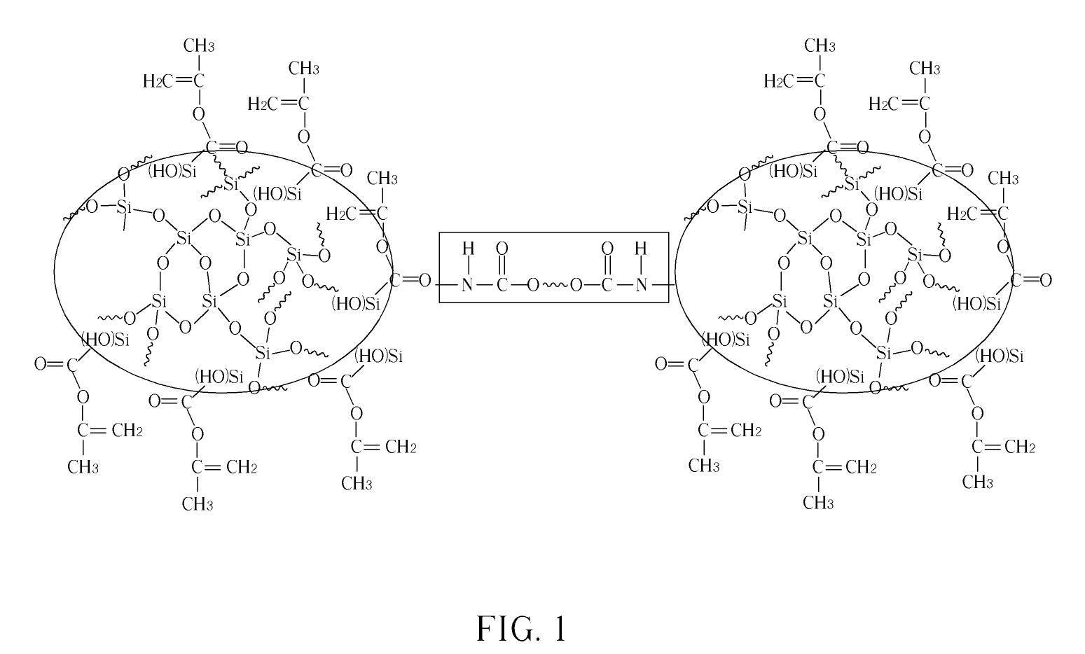

The modifier in the hard coating composition of the present invention is an oligomer of multiple functional groups formed by polyol- or polyester-type polyurethane prepolymer with alternate hard and soft chains and silica, as illustrated in FIG. 1. When going with a conventional hard coating composition, it may increase the hardness of the hard coating composition and the optical film obtained from the hard coating modifier of the present invention may avoid the traditional disadvantageous curling problem.

The inorganic network formed by the silicon oxide may furnish the hard coating with a structurally rigid backbone so as to effectively strengthen the structure of the hard coating. The silicon oxide is coated with abundant of active vinyl functional groups. When the active vinyl functional groups co-react with the hard coating composition, it may increase the cross-linking density to further enhance the hardness of the material.

Please note that the viscosity will suddenly increase when the cross-linking density dramatically bursts forth instantly. If the accompanied stress cannot be released at the same time, serious and disadvantageous curling problem may occur. Accordingly, in the structure of the hard coating modifier, the polyurethane structure with alternate hard and soft moieties is expected to act as releasing the stress and easing the curling problem when cured. The addition of the hard coating modifier may effectively raise the hardness of the hard coating film and simultaneously avoids the curling problem due to curing. The polyurethane cross-linked silica modifier of the present invention may be added into the hard coating composition at a proper proportion and polymerized with the hard coating composition by UV light through the active vinyl functional groups.

The present invention first proposes a reactive polymer for use as a modifier of the conventional hard coating composition. The reactive polymer of the present invention has the following representative formula:

R₄—R_{3b}—NH—CO—R_{2b}—CO—NH—R₁—NH—CO—R₂ₐ—CO—NH—R₃ₐ—R₄

wherein,
R₁ is alkylene, arylene or the combination thereof;
R₂ₐ is —{[O—(CH₂)ₐ]_{b}}—O—
or

—O[—(CH₂)_{d}—OOC—(CH₂)_{d}—COO]ₑ}—(CH₂)_{d}—O—,

wherein a is between 2-50, b is between 1000-2000, d is between 2-50 and e is between 1000-2000;
R_{2b} is —{[O—(CH₂)ₕ]ₖ}—O—
or

—O[—(CH₂)_{f}—OOC—(CH₂)_{f}—COO]_{g}}—(CH₂)_{f}—O—,

wherein h is between 2-50, k is between 1000-2000, f is between 2-50 and g is between 1000-2000;
R₃ₐ is a cross-linked poly (—Si—O—) group;
R_{3b} is a cross-linked poly (—O—Si—) group; and
R₄ is a vinyl functional group.

R₁ may be branched or unbranched alkylene group such as methylene (—CH₂—), ethylene (—CH₂CH₂—), isopropylene (—CH₂(CH₃)CH—), or phenyl-containing arylene, such as phenylene

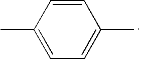

R₁ may also be the combination of alkylene and arylene, such as methylenephenylenemethylene

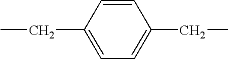

or phenylenemethylenephenylene

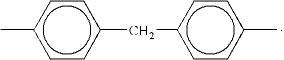

The moiety (—CO—NH—R₁—NH—CO—) is deemed as a polyurethane prepolymer moiety. If the moiety has at least one phenyl ring, the main chain of the reactive polymer of the present invention is more rigid.

R₂ₐ may be a moiety of polyol type or polyester type. The polyol type may be —{[O—(CH₂)ₐ]_{b}}—O—, which may be formed by the polymerization of ethylene oxide (a=2), propylene oxide (a=3), or butylene oxide (a=4). R₂ₐ may include 1000-2000 polymeric monomers so that b is between 1000-2000. Similarly, the polyester type moiety, for example —O[—(CH₂)_{f}—OOC—(CH₂)_{f}—COO]_{g}}—(CH₂)_{f}—O—, may be formed by suitable aliphatic dicarboxylic acids with excess diols. For example, if adipic acid (or a.k.a. hexanedioic acid) reacts with excess butanediol, they yield —O[—(CH₂)₄—OOC—(CH₂)₄—COO]ₑ}—(CH₂)₄—O— moiety (d=4) so that e is between 1000-2000. On the other hand, R_{2b} is similar to R₂ₐ but they are independent of each other. If the molecular weight and the type of the polyol and of the polyester are well controlled, the softness of the chains of the reactive polymer of the present invention can be well controlled.

R₃ₐ and R_{3b} are respectively independent cross-linked polysilicate (—Si—O—). Generally speaking, R₃ₐ and R_{3b} may respectively include 10 or more (—Si—O—) units. Optionally, each (—Si—O—) unit may include free —OH groups.

R₄ group includes at least one double bond, such as a vinyl functional group, polymerizable under a suitable condition, such as UV light. Suitable vinyl functional groups are, for example, alkenyl-alkoxylene group. The representative alkenyl-alkoxylene group may be acryloyl-ethylene (H₂C═CHCOO—C₂H₄—) or methacryloyl-ethylene (H₂C═C(CH₃)COO—C₂H₄—).

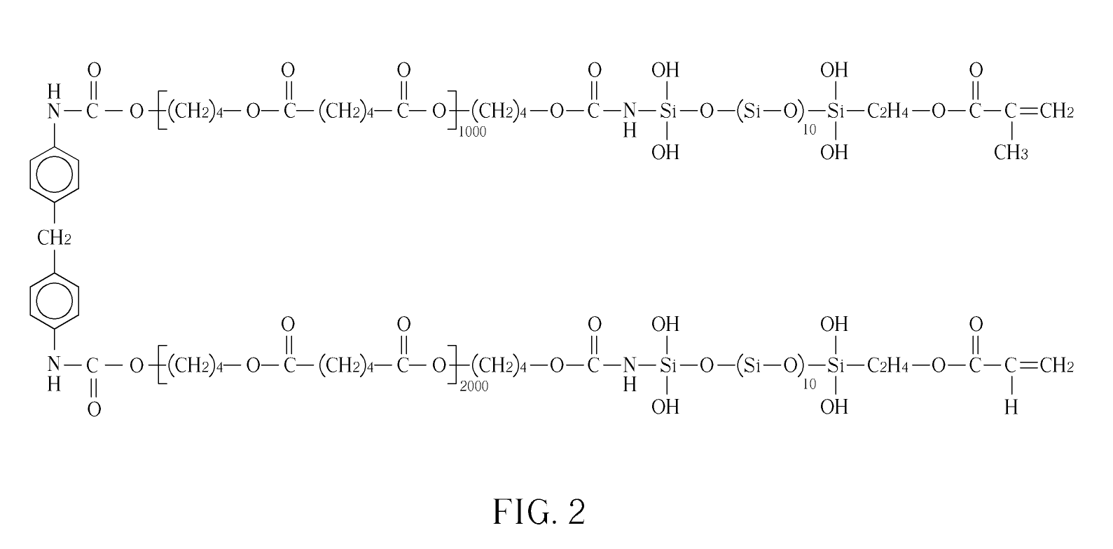

FIG. 2 illustrates the chemical formulae of the representative examples of the reactive polymers of the present invention.

The reactive polymers of the present invention may be used as a modifier for the conventional hard coating composition. Accordingly, the present invention also provides a hard coating composition including the reactive polymers of the present invention. The hard coating composition of the present invention includes a reactive polymer, an acrylate-type monomer, an acrylate-type oligomer and a photo initiator. The acrylate-type monomer may be products of CD277, CD420, CD484, CD551, SR285, SR506, SR379 or SR238 from SARTOMER. The acrylate-type oligomer may be products of CN968, CN981, CN293 or CN2300 from SARTOMER. The photo initiator may be a free-radical initiator such as IRGACURE 184, IRGACURE 2959 or IRGACURE 1173 from CIBY or a cation initiator such as CD-1010, CD-1012 or KI-85. The hard coating composition of the present invention may contain 0.5%-15% (total), preferably 3%-5% (total) of the reactive polymer.

The reactive polymer has the following representative formula:

R₄—R_{3b}—NH—CO—R_{2b}—CO—NH—R₁—NH—CO—R₂ₐ—CO—NH—R₃ₐ—R₄

wherein,
R₁ is alkylene, arylene or the combination thereof,
R₂ₐ is —{[O—(CH₂)ₐ]_{b}}—O—
or

—O[—(CH₂)_{d}—OOC—(CH₂)_{d}—COO]ₑ}—(CH₂)_{d}—O—,

wherein a is between 2-50, b is between 1000-2000, d is between 2-50 and e is between 1000-2000,
R_{2b} is —{[O—(CH₂)ₕ]ₖ}—O—
or

—O[—(CH₂)_{f}—OOC—(CH₂)_{f}—COO]_{g}}—(CH₂)_{f}—O—,

wherein h is between 2-50, k is between 1000-2000, f is between 2-50 and g is between 1000-2000,
R₃ₐ is a cross-linked poly (—Si—O—) group,
R_{3b} is a cross-linked poly (—O—Si—) group, and
R₄ is a vinyl functional group.

R₁ may be branched or unbranched alkylene group such as methylene (—CH₂—), ethylene (—CH₂ CH₂—), isopropylene (—CH₂(CH₃)CH—), or phenyl-containing arylene, such as phenylene

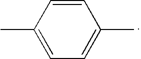

R₁ may also be the combination of alkylene and arylene, such as methylenephenylenemethylene

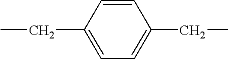

or phenylenemethylenephenylene

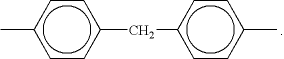

The moiety (—CO—NH—R₁—NH—CO—) is deemed as a polyurethane prepolymer moiety. If the moiety has at least one phenyl ring, the main chain of the reactive polymer of the present invention is more rigid.

R₂ₐ may be a moiety of polyol type or polyester type. The polyol type may be —{[O—(CH₂)ₐ]_{b}}—O—, which may be formed by the polymerization of ethylene oxide (a=2), propylene oxide (a=3), or butylene oxide (a=4). R₂ₐ may include 1000-2000 polymeric monomers so that b is between 1000 and 2000. Similarly, the polyester type moiety, for example —O[—(CH₂)_{f}—OOC—(CH₂)_{f} —COO]_{g}}—(CH₂)_{f}—O—, may be formed by suitable aliphatic dicarboxylic acids with excess diols. For example, if adipic acid (or a.k.a. hexanedioic acid) reacts with excess butanediol, they yield —O[—(CH₂)₄—OOC—(CH₂)₄—COO]ₑ}—(CH₂)₄—O— moiety (d=4) so that e is between 1000-2000. On the other hand, R_{2b} is similar to R₂ₐ but they are independent of each other. If the molecular weight and the type of the polyol and of the polyester are well controlled, the softness of the chains of the reactive polymer of the present invention can be well controlled.

R₃ₐ and R_{3b} are respectively independent cross-linked polysilicate (—Si—O—). Generally speaking, R₃ₐ and R_{3b} may respectively include 10 or more (—Si—O—) units. Optionally, each (—Si—O—) unit may include free —OH groups.

R₄ group includes at least one double bond, such as a vinyl functional group, polymerizable under a suitable condition, such as UV light. Suitable vinyl functional groups are, for example, alkenyl-alkoxylene group. The alkenyl-alkoxylene group may be acryloyl-ethylene (H₂C═CHCOO—C₂H₄—) or methacryloyl-ethylene (H₂C═C(CH₃)COO—C₂H₄—).

The combination of the ingredients of the reactive polymer, the acrylate-type monomer, the acrylate-type oligomer and the photo initiator in the composition of the present invention are commercially available, for example, the Hard coating HC 205 from Japan Adeka or the Hard coating B-500 from Japan Shin-Kakamura. The hard coating composition of the present invention has pencil hardness not less than 3H in the presence of the modifier.

### EXAMPLES OF THE HARD COATING COMPOSITION OF THE PRESENT INVENTION

The following examples are provided for the demonstration of the hard coating composition of the present invention only and not intended to limit the scope of the present invention.

### Example 1

The commercially available Hard coating HC 205 (about 50% solid content) from Japan Adeka is mixed with the modifier (3-5%) for hard coating composition of the present invention. The mixture is evenly mixed and applied on a transparent plastic substrate such as PET or TAC by a wet coating method. First, it is baked in an oven at 80° C. for 1 minute. An optical film is obtained after a curing procedure by being exposed to 480 MJ/cm² accumulated illuminance energy.

### Example 2

The commercially available Hard coating B-500 (about 50% solid content) from Japan Shin-Kakamura is mixed with the modifier (3-5%) for hard coating composition of the present invention. The mixture is evenly mixed and applied on a transparent plastic substrate such as PET or TAC by a wet coating method. First, it is baked in an oven at 80° C. for 1 minute. An optical film is obtained after a curing procedure by being exposed to 480 MJ/cm² accumulated illuminance energy.

### Comparative Example 1

The commercially available Hard coating HC 205 (about 50% solid content) from Japan Adeka is applied on a transparent plastic substrate such as PET or TAC by a wet coating method. First, it is baked in an oven at 80° C. for 1 minute. An optical film is obtained after a curing procedure by being exposed to 480 MJ/cm² accumulated illuminance energy.

### Comparative Example 2

The commercially available Hard coating B-500 (about 50% solid content) from Japan Shin-Kakamura is applied on a transparent plastic substrate such as PET or TAC by a wet coating method. First, it is baked in an oven at 80° C. for 1 minute. An optical film is obtained after a curing procedure by being exposed to 480 MJ/cm² accumulated illuminance energy.

Testing

### 1. Transmittance and Haze

The sample is 5 cm by 5 cm according to JIS K7136 and tested by NDH-2000 (Nippon Denshoku). The film surface faces the integration ball and the illumination comes from the left side. The data collected from the integration ball is integrated to obtain the haze.

### 2. Abrasion Test

Steel wool (type #0000) is loaded with different weights (100 g, 200 g, 500 g) to scratch the surface of the film 10 times repeatedly. Less than 5 scratches is a pass.

### 3. Adherence

The testing of adherence is in accordance with JIS K-5400. The film to be tested is placed on a glass pace, facing up. The adhesive tapes (Nichiban) in a cross-like arrangement are peeled off at 90 degree angle to observe if there is any hard coating resin to be taken along with.

### 4. Thickness

The thickness of the film is measured by an electronic spiral micrometer (Mituto).

### 5. Pencil Hardness

The testing is in accordance with JIS K5600 by ERICHSEN apparatus. The pencil is “Hi-uni MITSU-BISHI” by Mitsubishi. The film to be tested is placed on a glass pace, facing up. Pencils of different hardness with loaded weight 750 g scratch the surface of the film at a 45 degree angle for 5 times to observe if there is any scratch caused. Pencils of higher hardness are used till scratches are present. The results are listed in Table 1.

TABLE 1

| | TT | Hz | ABRASION | | | PENCIL |
|---|---|---|---|---|---|---|
| Samples | (%) | (%) | (gw/cm²) | ADHERENCE (%) | THICKNESS | HARDNESS |
| Example 1 | 90.39 | 0.21 | 250 | 0 | 5 μm | 3H |
| Example 2 | 90.32 | 0.29 | 250 | 0 | 5 μm | 3H |
| Com. | 90.10 | 0.31 | 250 | 0 | 5 μm | 2H |
| Ex. 1 | | | | | | |
| Com. | 90.52 | 0.19 | 250 | 0 | 5 μm | 2H |
| Ex. 2 | | | | | | |

It is observed from the examples that the hard coating composition of the present invention is good in transmittance, haze, abrasive-resistance, adherence and thickness. The hard coating composition of the present invention has normal haze and the hardness is not less than 3H pencil hardness.

The present invention further provides a method to make a reactive polymer for use as a modifier of the conventional hard coating composition. The hard coating composition modifier is obtained by reacting 1 eqv. organic diisocynate, 1 eqv. inorganic isocynatesiloxane with 2 eqv. polyols or polyesters through condensation. If the molecular weight and the type of the polyol and of the polyester are well controlled, the softness of the chains of the reactive polymer of the present invention can be well controlled. If the organic diisocynate has at least one phenyl ring, the main chain of the reactive polymer of the present invention is more rigid.

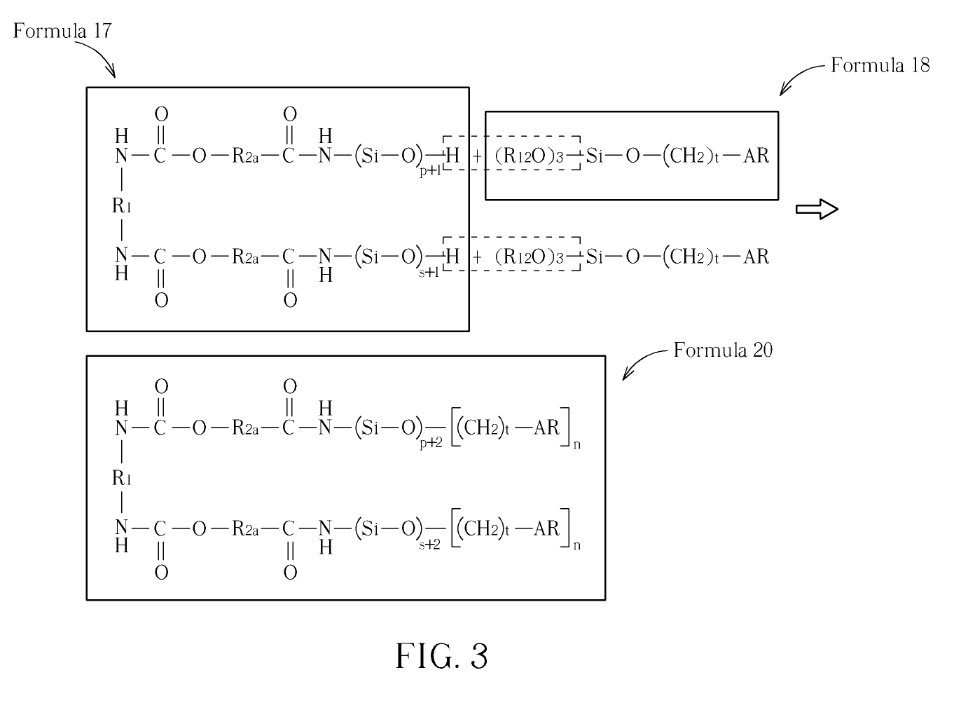

The method to make the reactive polymer of the present invention involves reacting a compound of formula (17) with an excessive amount of a compound of formula (18) to obtain a compound of formula (20). This procedure may modify the outer portion of the silica molecular cluster with reactive (meth) acrylic group and siloxane. The number of the functional groups is optional. The more functional groups there are, the higher the cross-linked density is, or the better the mechanical strength or the hardness is. FIG. 3 illustrates the compound of formula (17) reacting with an excessive amount of the compound of formula (18) to obtain the compound of formula (20).

The compound of formula (17) is

H—(O—Si)_{S+1}—NH—CO—R_{2b}—CO—NH—R₁—NH—CO—R₂ₐ—OC—NH—(Si—O)_{P+1}—H.

R₁ may be branched or unbranched alkylene group such as methylene (—CH₂—), ethylene (—CH₂CH₂—), isopropylene (—CH₂(CH₃)CH—), or phenyl-containing arylene, such as phenylene

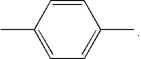

R₁ may also be the combination of alkylene and arylene, such as methylenephenylenemethylene

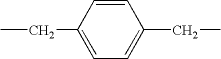

or phenylenemethylenephenylene

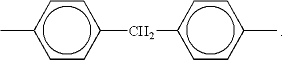

The moiety (—CO—NH —R₁—NH—CO—) is deemed as a polyurethane prepolymer moiety to render the main chain of the reactive polymer of the present invention more flexible.

R₂ₐ may be a moiety of polyol type or polyester type. The polyol type may be —{[O—(CH₂)ₐ]_{b}}—O—, which may be formed by the polymerization of ethylene oxide (a=2), propylene oxide (a=3), or butylene oxide (a=4). R₂ₐ may include 1000-2000 polymeric monomers so that b is between 1000 and 2000. Similarly, the polyester type moiety, for example —O[—(CH₂)_{f}—OOC—(CH₂)_{f}—COO]_{g}}—(CH₂)_{f}—O—, may be formed by suitable aliphatic dicarboxylic acids with excess diols. For example, if adipic acid (or a.k.a. hexanedioic acid) reacts with excess butanediol, they yield —O[—(CH₂)₄—OOC—(CH₂)₄—COO]ₑ}—(CH₂)₄—O— moiety (d=4) so that e is between 1000 and 2000. On the other hand, R_{2b} is similar to R₂ₐ but they are independent of each other.

Moreover, —(O—Si)_{S+1}— and —(Si—O)_{P+1}— each represents an independent cross-linked polysilicate (−Si—O—). P is between 2 and 50 and s is the same as p. Optionally, each —(O—Si)_{S+1}— and —(Si—O)_{P+1}— may include free —OH group.

The compound of formula (18) is

[AR—(CH₂)ₜ—O—Si—(OR₁₂)₃] formula (18)

AR group includes at least one double bond, such as a vinyl functional group, polymerizable under a suitable condition, such as UV light. Suitable vinyl functional groups are, for example acryloyl (H₂C═CHCOO—) or methacryloyl (H₂C═C(CH₃)COO—). R₁₂ is a protection group, for example C₁-C₁₀ alkyl group, and t is between 2-10.

The compound of formula (20) is

[AR—(CH₂)ₜ—]ₘ(O—Si)_{S+2}—NH—CO—R_{2b}—CO—NH—R₁—NH—CO—R₂ₐ—OC—NH—(Si—O)_{P+2}—[(CH₂)ₜ—AR]ₙ,

wherein m is between 1-10, and n is between 1-10.

For example,

[H₂C═C(CH₃)COO—(CH₂)₂—O—Si—(OC₂H₅)₃]+[H₂C═CHCOO—(CH₂)₂—O—Si—(OC₂H₅)₃] representative formula (18)

is first hydrolyzed in water with the catalysis of diluted acid. Then it reacts with

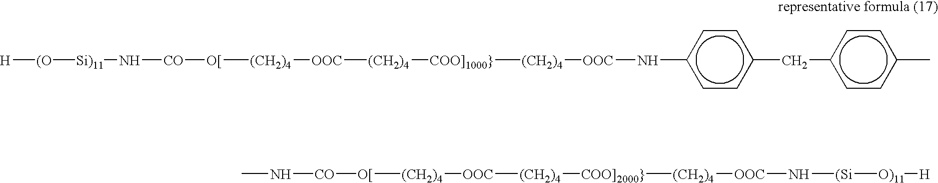

to yield

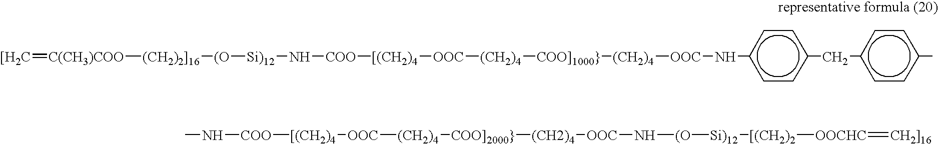

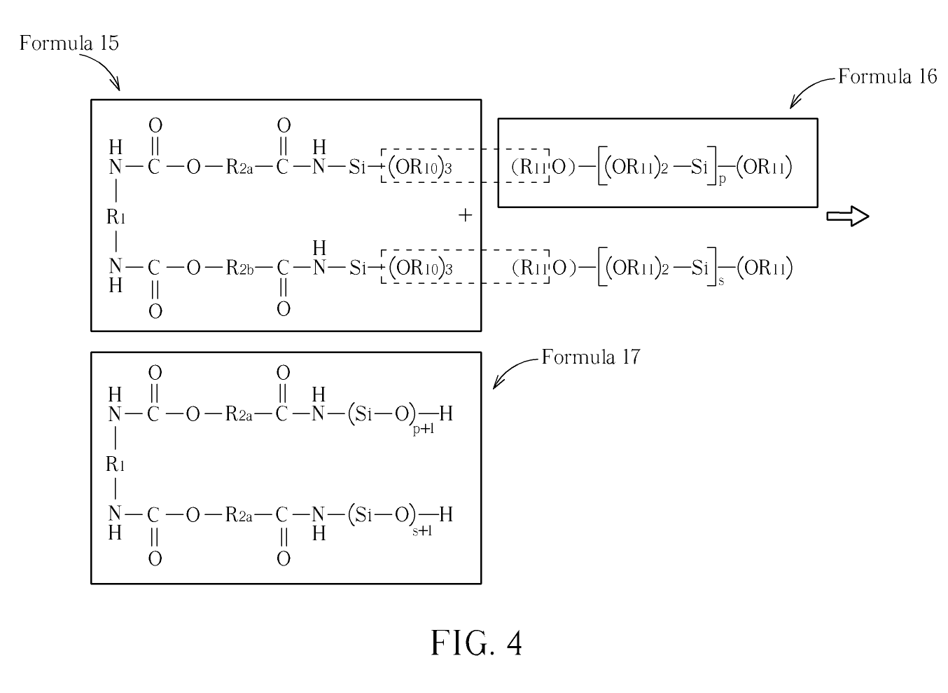

To obtain the compound of formula (17), the compound of formula (15) reacts with an excessive amount of the compound of formula (16). FIG. 4 illustrates the compound of formula (15) reacting with an excessive amount of the compound of formula (16) to obtain the compound of formula (17).

The compound of formula (15) is

(OR₁₀)₃—Si—NH—CO—R_{2b}—CO—NH—R₁—NH—CO—R₂ₐ—OC—NH—Si—(OR₁₀)₃ formula (15)

R₁₀ is a protection group, for example C₁-C₁₀ alkyl group.

The compound of formula (16) is

(R₁₁O)—[(OR₁₁)₂—Si]_{P}—(OR₁₁) formula (16)

R₁₁ is a protection group, for example C₁-C₁₀ alkyl group.

For example,

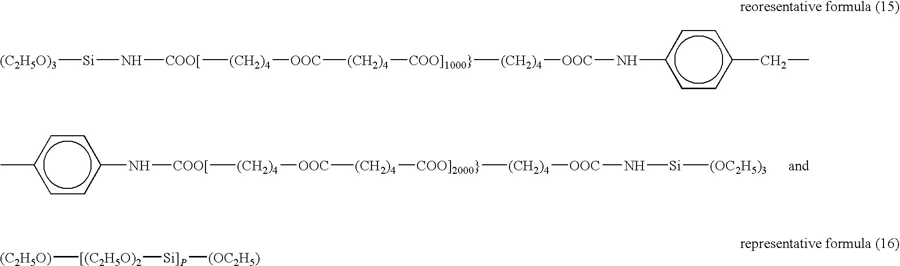

are hydrolyzed in water with the catalysis of diluted acid. The compounds of formula (15) and (16) may be hydrolyzed together or separately.

Then, the compounds of formula (15) and (16) react together to yield

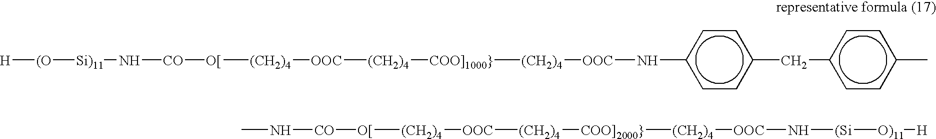

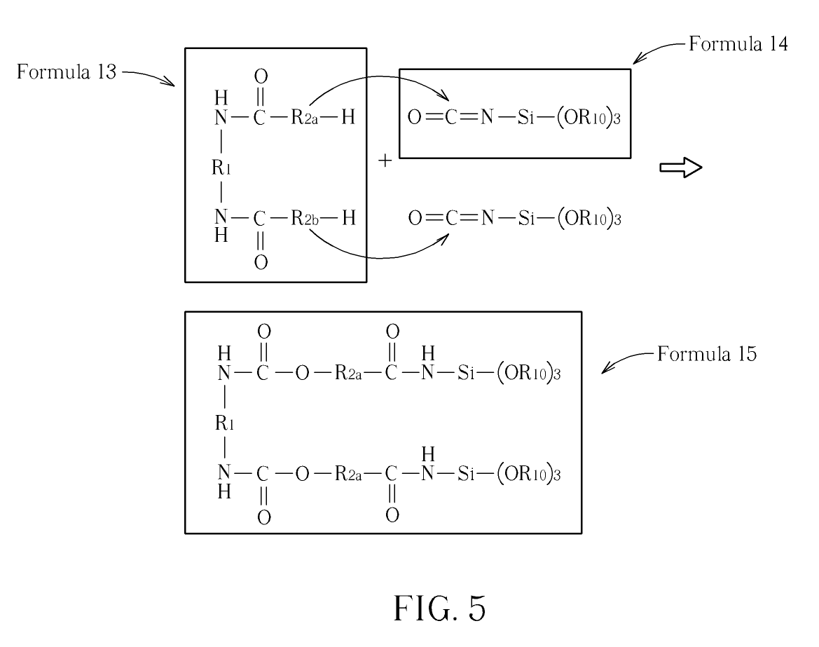

To obtain the compound of formula (15), the compound of formula (13) reacts with an excessive amount of the compound of formula (14). FIG. 5 illustrates the compound of formula (13) reacting with an excessive amount of the compound of formula (14) to obtain the compound of formula (15).

The compound of formula (13) is

H—R_{2b}—CO—NH—R₁—NH—CO—R₂ₐ—H formula (13)

and the compound of formula (14) is

O═C═N—Si—(OR10)₃ formula (14).

For example,

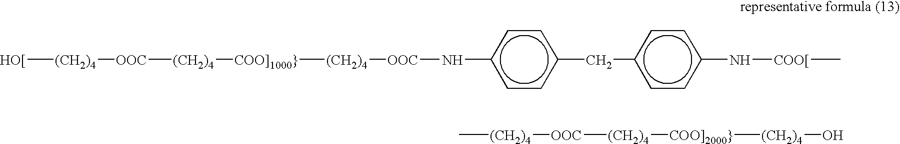

reacts with

O═C═N—Si—(OC₂H₅)₃ representative formula (14)

under 70° C. temperature for 2-3 hours to yield

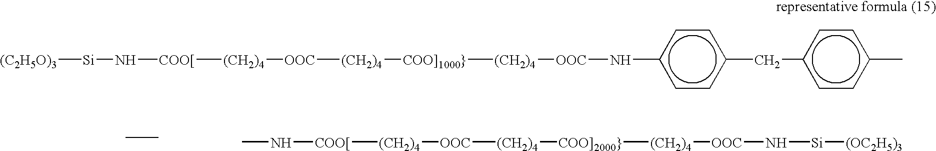

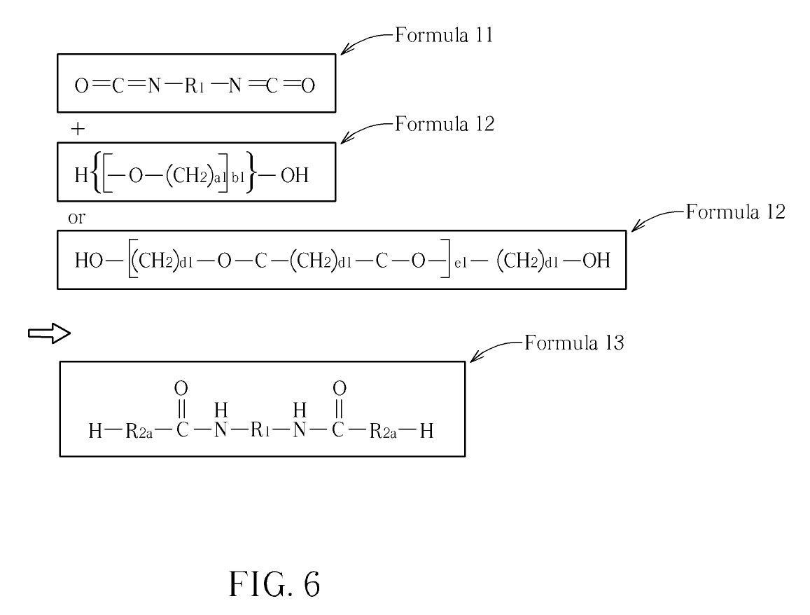

To obtain the compound of formula (13), the compound of formula (11) reacts with an excessive amount of the compound of formula (12). FIG. 6 illustrates the compound of formula (11) reacting with an excessive amount of the compound of formula (12) to obtain the compound of formula (13).

The compound of formula (11) is

O═C═N—R₁—N═C═O formula (11)

and the compound of formula (12) is

H{[—O—(CH₂)ₐ₁]_{b1}}—OH

or

HO—[(CH₂)_{d1}—OOC—(CH₂)_{d1}—COO]ₑ1-(CH₂)_{d1}—OH.

The compound of formula (12) may be polyol or polyester. (a1) of the polyol may be between 2 and 50. For example the compound of formula (12) may be formed by the polymerization of ethylene oxide (a=2), propylene oxide (a=3), or butylene oxide (a=4) to form polyol and to include 1000-2000 polymeric monomers so that b1 is between 1000 and 2000. Similarly, d1 of the polyester may be between 2 and 50, for instance formed by suitable aliphatic dicarboxylic acids with excess diols. For example, if adipic acid (or a.k.a. hexanedioic acid) reacts with excess butanediol, they yield HO[—(CH2)₄—OOC—(CH2)₄—COO]ₑ}—(CH2)₄—OH so that e is between 1000 and 2000.

For example, the mixture of

HO[—(CH₂)₄—OOC—(CH₂)₄—COO]₁₀₀₀}—(CH₂)₄—OH

and

HO[—(CH₂)₄—OOC—(CH₂)₄—COO]₂₀₀₀}—(CH₂)₄—OH

is stirred and heated up to 70° C. and added into

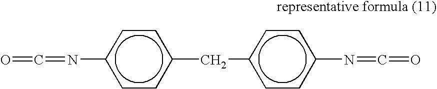

dropwisely to yield

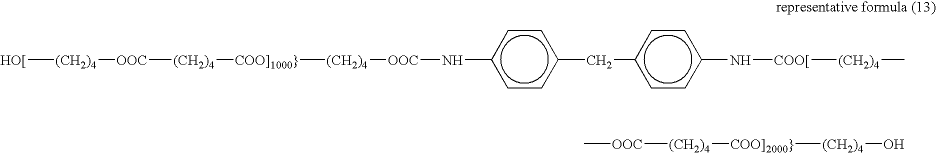

Please note that the above reaction should be carried out in an anhydrous condition.

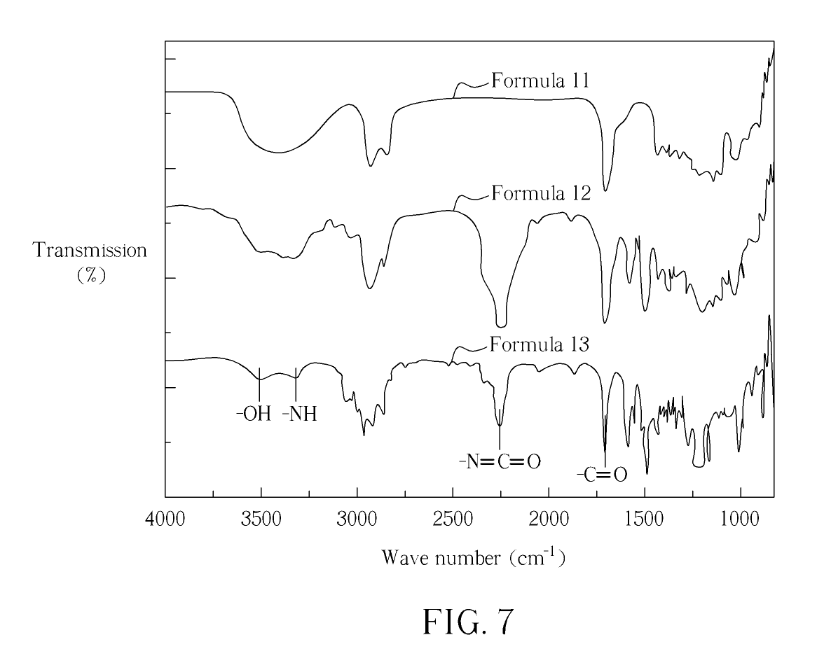

The IR spectrum of formulae (11), (12) and (13) are shown in FIG. 7, which illustrates the characteristic absorption of the representative function groups.

Those skilled in the art will readily observe that numerous modifications and alterations of the device and method may be made while retaining the teachings of the invention.

What is claimed is:

1. A reactive polymer of the following representative formula:
R₄—R_{3b}—NH—CO—R_{2b}—CO—NH—R₁—NH—CO—R₂ₐ—CO—NH—R₃ₐ—R₄
wherein,
R₁ is alkylene, arylene or the combination thereof;
R₂ₐ is —{[O—(CH₂)ₐ]_{b}}—O— or —O[—(CH₂)_{d}—OOC—(CH₂)_{d}—COO]ₑ}—(CH₂)_{d}—O—, wherein a is between 2 and 50, b is between 1000 and 2000, d is between 2 and 50 and e is between 1000 and 2000;
R_{2b} is —{[O—(CH₂)ₕ]ₖ}—O— or —O[—(CH₂)_{f}—OOC—(CH₂)_{f}—COO]_{g}}—(CH₂)_{f}—O—, wherein h is between 2 and 50, k is between 1000 and 2000, f is between 2 and 50 and g is between 1000 and 2000;
R₃ₐ is a cross-linked poly (—Si—O—) group;
R_{3b} is a cross-linked poly (—O—Si—) group; and
R₄ is a vinyl functional group.

2. The reactive polymer of claim 1, wherein R₁ is

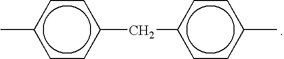

3. The reactive polymer of claim 1, wherein d is 4 and f is 4.

4. The reactive polymer of claim 1, wherein R₄ is methacryloyl-ethylene.

5. The reactive polymer of claim 1, wherein R₄ is polymerizable in the presence of UV light.

6. A hard coating composition, comprising:
a reactive polymer of the following representative formula:
R₄—R_{3b}—NH—CO—R_{2b}—CO—NH—R₁—NH—CO—R₂ₐ—CO—NH—R₃ₐ—R₄
wherein,
R₁ is alkylene, arylene or the combination thereof,
R₂ₐ is —{[O—(CH₂)ₐ]_{b}}—O— or —O[—(CH₂)_{d}—OOC—(CH₂)_{d}—COO]ₑ}—(CH₂)_{d}—O—, wherein a is between 2 and 50, b is between 1000 and 2000, d is between 2 and 50 and e is between 1000 and 2000;
R_{2b} is —{[O—(CH₂)ₕ]ₖ}—O— or —O[—(CH₂)_{f}—OOC—(CH₂)_{f}—COO]_{g}}—(CH₂)_{f}—O—, wherein h is between 2 and 50, k is between 1000 and 2000, f is between 2 and 50 and g is between 1000 and 2000, R₃ₐ is a cross-linked poly (—Si—O—) group, R_{3b} is a cross-linked poly (—O—Si—) group, and
R₄ is a vinyl functional group;
an acrylic-type monomer;
an acrylic-type oligomer; and
a photo initiator.

7. The hard coating composition of claim 6, comprising 0.5%-15% of said reactive polymer.

8. The hard coating composition of claim 6, comprising 3%-5% of said reactive polymer.

9. The hard coating composition of claim 6, wherein R₁ is

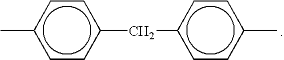

10. The hard coating composition of claim 6, wherein d is 4 and f is 4.

11. The hard coating composition of claim 6, wherein R₄ is methacryloyl-ethylene.

12. The hard coating composition of claim 6, wherein R₄ is polymerizable in the presence of UV light.

13. The hard coating composition of claim 6, having a hardness not less than 3H.

14. A method to make a reactive polymer, comprising:
reacting a compound of formula (17) with an excessive amount of a compound of formula (18) to obtain a compound of formula (20), wherein said compound of formula (17) is
H—(O—Si)_{S+1}—NH—CO—R_{2b}—CO—NH—R₁—NH—CO—R₂ₐ—OC—NH—(Si—O)_{P+1}—H,
R₁ is alkylene, arylene or the combination thereof, R₂ₐ is —{[O—(CH₂)ₐ]_{b}}—O— or —O[—(CH₂)_{d}—OOC—(CH₂)_{d}—COO]ₑ}—(CH₂)_{d}—O—,
wherein a is between 2 and 50, b is between 1000 and 2000, d is between 2 and 50 and e is between 1000 and 2000, R_{2b} is —{[O—(CH₂)ₕ]ₖ}—O— or —O[—(CH₂)_{f}—OOC—(CH₂)_{f}—COO]_{g}}—(CH₂)_{f}—O—, wherein h is between 2 and 50, k is between 1000 and 2000, f is between 2 and 50 and g is between 1000 and 2000, p is between 2 and 50, s is the same as p, (Si—O)_{P+1} and (O—Si)_{S+1} respectively represent a cross-linked poly (—Si—O—) group, said compound of formula (18) is
[AR—(CH₂)ₜ—Si—(OR₁₂)₃],
AR is a vinyl functional group, R₁₂ is C₁-C₁₀ alkyl, t is between 2-10,
and
said compound of formula (20) is
[AR—(CH₂)ₜ—]ₘ(O—Si)_{S+2}—NH—CO—R_{2b}—CO—NH—R₁—NH—CO—R₂ₐ—OC—NH—(Si—O)_{P+2}—[(CH₂)ₜ—AR]ₙ,
m is between 1 and 10, n is between 1 and 10.

15. The method of claim 14, further comprising:
reacting a compound of formula (15) with an excessive amount of a compound of formula (16) to obtain said compound of formula (17), wherein said compound of formula (15) is:
(OR₁₀)₃—Si—NH—CO—R_{2b}—CO—NH—R₁—NH—CO—R₂ₐ—OC—NH—Si—(OR₁₀)₃,
R₁₀ is C₁-C₁₀ alkyl, and
said compound of formula (16) is:
(OR₁₁)—[(OR₁₁)₂—Si]ₚ—(R₁₁O), R₁₁ is C₁-C₁₀ alkyl.

16. The method of claim 15, further comprising:
reacting a compound of formula (13) with an excessive amount of a compound of formula (14) to obtain said compound of formula (15), wherein said compound of formula (13) is:
H—R_{2b}—CO—NH—R₁—NH—CO—R₂ₐ—H, and
said compound of formula (14) is
OCN—Si—(OR₁₀)₃.

17. The method of claim 16, further comprising:
reacting a compound of formula (11) with an excessive amount of a compound of formula (12) to obtain said compound of formula (13), wherein said compound of formula (11) is:
(OCN—R₁—NCO),
said compound of formula (12) is
H{[—O—(CH₂)ₐ₁]_{b1}}OH
or
HO[—(CH₂)_{d1}—OOC—(CH₂)_{d1}—COO]ₑ₁}—(CH₂)_{d1}—OH,
a₁ is between 2 and 50, b₁ is between 1000 and 2000, d₁ is between 2 and 50, and e₁ is between 1000 and 2000.

18. The method of claim 14, wherein R₁ is

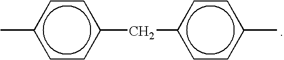

19. The method of claim 14, wherein a, d, h, f all are 4.

20. The method of claim 14, wherein R₁₂ is ethyl.

21. The method of claim 15, wherein R₁₀ and R₁₁ all ethyl.

22. The method of claim 14, wherein p and s all are 10.

23. The method of claim 14, wherein t is 2.

24. The method of claim 14, wherein said AR group is polymerizable in the presence of UV light.

25. The method of claim 14, wherein said AR group is (meth)acryloyl.
